(19) United States
(12) Patent Application Publication
(10) Pub. No.: US 2014/0069395 A1
(43) Pub. Date: Mar. 13, 2014

(54) ELECTROMAGNETIC WAVE TREATMENT METHOD OF WATER VAPOR IN COMBUSTION AIR AND ELECTROMAGNETIC WAVE TREATMENT APPARATUS OF WATER VAPOR IN COMBUSTION AIR

(71) Applicant: Yasushi Shikanai, Aomori (JP)

(72) Inventor: Yasushi Shikanai, Aomori (JP)

(73) Assignees: SAINT INVESTMENT INC., Aomori (JP); JAPAN ECO SUPPORTER CO., LTD., Aomori (JP)

(21) Appl. No.: 13/201,346

(22) PCT Filed: Jun. 8, 2011
(86) PCT No.: PCT/JP2011/003248

§ 371 Date: Nov. 21, 2011

(30) Foreign Application Priority Data
May 30, 2011 (JP) 2011-119870

(51) Int. Cl. F02M 27/04

(52) U.S. Cl. CPC F02M 27/04
USPC 123/539

(57) ABSTRACT

[Problems] Temperature unevenness of compressed air in a combustion chamber of an internal combustion engine delays a reaction between a fuel and combustion air, thereby inevitably inducing ignition delay. The existing combustion always discharges exhaust harmful substances (including blow-by gas) as incomplete combustion. The ignition delay of the existing combustion is suppressed.

[Means for Resolution] Electromagnetic wave treatment method of water vapor in combustion air excites water molecules of water vapor in the combustion air. Electromagnetic wave treatment apparatus for water vapor in combustion air comprises a substrate, a heat shield body attached to the substrate, an irradiator provided on the heat shield body and irradiating electromagnetic waves toward combustion air, and a storage space storing the irradiator therein.

### TECHNICAL FIELD

The present invention relates to an electromagnetic wave treatment method of water vapor in combustion air, which improves combustion efficiency in a combustion apparatus such as an internal combustion engine, thereby reducing a fuel and reducing exhaust harmful substances, and an apparatus thereof.

### BACKGROUND ART

In recent years, an internal combustion engine having higher combustion efficiency and small fuel consumption is required on the background of energy saving from global warming countermeasures. For this reason, internal combustion engines having a dilute combustion method and a technology of, for example, modification of a fuel become the mainstream. Those promote a reaction between a fuel and air (oxygen), and therefore had the object to improve combustion efficiency by ignition control by mechanically changing the structure in a combustion chamber and ignition control by changing an octane number of a fuel. However, the countermeasure was not taken in most internal combustion engines on the problem regarding water vapor contained in other combustion air, which gives great influence to the combustion efficiency.

The amount of water vapor (water vapor pressure) that air can contain has the limit, and the state that water vapor was contained up to the limit is called a saturated state. The amount of water vapor at that time is called the amount of saturated water vapor, and is represented by the amount (g) of water vapor contained in 1 m³ of air. The amount of saturated water vapor (saturated water vapor pressure) is increased with increasing the temperature.

Air has the property that the amount of water vapor is increased in prcportion to air temperature and saturated water vapor pressure as shown in Table 1 below.

TABLE 1
Water vapor that air can contain

| Temperature | Saturated water | Amount of saturated |
|---|---|---|
| (° C.) | vapor pressure (hpa) | water vapor (g/m³) |
| 0 | 6.10 | 4.8 |
| 10 | 12.28 | 9.4 |
| 20 | 23.38 | 17.3 |
| 30 | 42.41 | 30.4 |

With increase in the air temperature and the water vapor pressure, lack of oxygen in the air occurs and additionally, water vapor in the combustion air compressed in a combustion chamber aggregates as water droplets. This was one of great factors to make combustion efficiency low. Furthermore, the conventional internal combustion engine was structurally difficult to control water vapor in combustion air. Therefore, the removal of exhaust harmful substances discharged from the existing combustion was under the state that the removal must rely on a catalyst of a post-treatment apparatus and DPF (NOₓ and PM reduction apparatus).
Patent Document 1: JP-A-2011-021553
Patent Document 2: JP-A-2010-203366
Patent Document 3: JP-A-2009-209902

### DISCLOSURE OF THE INVENTION

### Problems that the Invention is to Solve

Examples of the combustion apparatus include various combustion equipments (a boiler, a stove and a drying oven) and various internal combustion engines (a gasoline engine, a diesel engine, a gas-fired engine, a turbine engine and the like).

The existing combustion of the internal combustion engines constituted as above has compensated for the lack of oxygen by controlling the reaction between a fuel and combustion air using an electronic control by a mechanical structure. On the other hand, it is less well-known that the internal combustion engine has the problem incurring ignition delay which is said to be fatal defect.

This is due to the following facts. The amount of water vapor is increased with the change of air temperature, so that lack of oxygen occurs in combustion air and additionally, water vapor in combustion air compressed in a combustion chamber aggregates as water droplets, thereby causing temperature unevenness in the compressed air. It is impossible in most cases to control the temperature unevenness with a mechanical structure.

The temperature unevenness of the compressed air in a combustion chamber of the above various internal combustion engines weakens the reaction between a fuel and combustion air and necessarily induces ignition delay. The existing combustion always discharges exhaust harmful substances (including blow-by gas) as incomplete combustion.

Exhaust harmful substances of incomplete combustion contain a large amount of unburned matters, and this causes a vicious cycle that carbon is contained in an engine oil, and the oil is deteriorated or deposits of carbon are formed in a combustion chamber, thereby slowing down a mechanical compression step of combustion air and remarkably decreasing combustion efficiency. Controlling the ignition delay of the predetermined combustion was the most important problem for the improvement of combustion efficiency.

The ignition delay decreases the combustion efficiency, and additionally decreases fuel efficiency, induces a large amount of fuel consumption, thereby leading to the result of promoting global warming, and discharges exhaust harmful substances, thereby bringing about air pollution.

An object of the present invention is to improve combustion efficiency of the existing combustion, and is to obtain an electromagnetic wave treatment method of water vapor in combustion air, that can reduce the fuel consumption and reduce exhaust harmful substances, and an electromagnetic wave treatment apparatus of water vapor in combustion air.

### Mean for Solving the Problems

To solve the above problems, an invention of a method described in claim 1 comprises irradiating combustion air fed to a combustion apparatus which extracts heat energy by burning materials to be burned, with electromagnetic waves, thereby exciting water molecules of water vapor in the combustion air.

The invention described in claim 1 is that when applied to, for example, an internal combustion engine of an autcomobile, the water vapor in the combustion air is irradiated with electromagnetic wave from an irradiator which received heat iron an engine room of an automobile and a heat source of an inhaled air passage section, and water molecules of the water vapor in the combustion air are excited, thereby causing further molecule oscillation action.

This action homogenizes temperature distribution of air when the combustion air has been compressed, and further can suppress temperature unevenness of the compressed air, thereby preventing ignition delay and increasing combustion efficiency. As a result, the fuel consumption is reduced, and additionally, exhaust harmful substances such as carbon dioxide (CO₂), carbon monoxide (CO), hydrocarbon (HC), nitrogen oxide (NOₓ) and suspended particulate matter (PM), contained in an exhaust gas are reduced.

In detail, when electromagnetic wave is absorbed in a gas having polarity such as carbon dioxide gas (CO₂) or water vapor (H₂O), further molecule oscillation action called excitation occurs. This is a mechanism of radiant heat transfer, and air is converted into a gas which easily raises temperature. It is said that climate change occurring on the earth at present, in detail, global warming, is the same action.

As the absorption action of electromagnetic wave generally well-known, it says that the principle of a microwave oven is the same action. Water absorbs electromagnetic waves (UHF waves) irradiated from a magnetron in the microwave oven, and excites water molecules (H₂O). The water molecule causes further oscillation action, and water molecules generate friction heat. Thus, water generates heat by itself, and changes into hot water.

The invention described in claim 2 is that the combustion apparatus is an internal combustion engine.

The “internal combustion engine” used herein means, for example, a gasoline engine, a diesel engine, a gas-fired engine and a turbine engine.

Therefore, in the case that the present invention is applied to various internal combustion engines, combustion efficiency of various internal combustion engines is increased, the fuel consumption is reduced, and exhaust harmful substances such as carbon dioxide (CO₂), carbon monoxide (CO), hydrocarbon (HC), nitrogen oxide (NOₓ) and suspended particulate matter (PM), contained in an exhaust gas are reduced.

The invention described in claim 3 is that the combustion apparatus is a heat generation type combustion engine. The “heat generation type combustion engine” used herein means various “engines that utilize heat obtained by burning a fuel”, and includes a boiler, a stove and a drying furnace.

Therefore, combustion efficiency of various internal combustion apparatuses is increased, the fuel consumption is reduced, and exhaust harmful substances such as carbon dioxide (CO₂), carbon monoxide (CO), hydrocarbon (HC), nitrogen oxide (NOₓ) and suspended particulate matter (PM), contained in an exhaust gas are reduced.

In the invention of an article described in claim 4, the article is mounted on a combustion apparatus which extracts heat energy by burning a material to be burned, and comprises a substrate, a heat shield body attached to the substrate, an irradiator provided on the heat shield body and irradiating electromagnetic waves toward combustion air, and a storage space storing the irradiator therein.

In the invention described in claim 5, the irradiator is formed by applying pasty ceramics to the surface of a base material comprising a paper.

The irradiator is formed by powdering ceramics with appropriate means to form a powder, mixing the powder with an appropriate binder to form a paste, and applying the pasty ceramics to the surface of a base material comprising a paper.

It is empirically recognized that so-called ceramics such as burned products and potteries, burned at high temperature emit electromagnetic waves. For example, it is empirically known that the phenomenon that foods placed in a pottery-made cup is difficult to cool down is due to a heat-retention effect by electromagnetic waves emitted from the pottery itself. It is considered that foods contain water, and excitation action (molecular oscillation) of water molecules is induced by electromagnetic waves irradiated from the pottery, thereby the heat-retention effect is generated. The present invention adopts this theory.

In the invention described in claim 6, the heat shield body is made of aluminum.

In the invention described in claim 7, the substrate is formed in a band form, and has a joint part at the end thereof.

Therefore, because the substrate is provided with the joint part at the end thereof in the invention described in claim 7, the band-form substrate can be used by winding around various materials to be mounted.

In the invention described in claim 8, the joint part is a planar fastener.

In the invention described in claim 9, the combustion apparatus is an internal combustion engine.

The “internal combustion engine” means a gasoline engine, a diesel engine, a gas-fired engine, a turbine engine, and the like.

Therefore, in the case that the present invention is applied to various internal combustion engines, the combustion efficiency of various internal combustion apparatuses is increased, the fuel consumption is reduced, and exhaust harmful suustances such as carbon dioxide (CO₂), carbon monoxide (CC), hydrocarbon (HC), nitrogen oxide (NOₓ) and suspended particulate matter (PM), contained in an exhaust gas are reduced.

In the invention described in claim 10, the combustion apparatus is a heat generation type combustion equipment. The “heat generation type combustion engine” used herein means various “engines utilizing heat obtained by burning a fuel”, and includes, for example, a boiler, a stove, and a drying oven.

### Advantage of the Invention

According to the electromagnetic wave treatment method of water vapor in combustion air and an apparatus thereof, according to the inventions described in claims 1 to 10, water molecules of water vapor are excited by electromagnetic waves emitted from an irradiator to cause further molecular oscillation action, this action homogenizes temperature distribution of air when combustion air is compressed, and furthermore, temperature unevenness of the combustion air can be suppressed. This develops the effects that ignition delay necessarily generated in the existing combustion is controlled, the combustion efficiency is improved, the fuel consumption is reduced, and exhaust harmful substances such as carbon dioxide (CO₂), carbon monoxide (CO), hydrocarbon (HC), nitrogen oxide (NOₓ) and suspended particulate matter (PM), contained in an exhaust gas are reduced.

In the inventions described in claims 2 and 9, from that the present invention is applied to an internal combustion engine, in the case of being mounted on an automobile, by mounting the apparatus to the existing vehicles as well as new cars, the ignition delay of the existing combustion is improved, shock wave of combustion is softened, combustion noise is reduced, cleaning combustion in which combustion time was prolonged is conducted, the combustion converts into combustion free of unburned materials, deposits in a combustion chamber are gradually cleaned by the cleaning combustion, and the combustion efficiency can gradually be improved. Therefore, in the existing cars having mounted thereon a catalyst and DPF (NOₓ and PM reduction apparatus) known as a post-treatment apparatus for exhaust gas, clogging of the catalyst and PDF filter is prevented, and this brings about life-extending effect.

In the inventions described in claims 3 and 10, from that the present invention is applied to a combustion engine, in the case of being applied to a boiler, a stove and the like, the ignition delay of the existing combustion is improved, shock wave of combustion is softened, combustion noise is reduced, cleaning combustion in which combustion time was prolonged is conducted, the combustion converts into combustion free of unburned materials, deposits in a combustion chamber are gradually cleaned by the cleaning combustion, and the combustion efficiency can gradually be improved.

### BRIEF DESCRIPTION OF THE DRAWINGS

FIG. 1 is a perspective view showing one embodiment of an electromagnetic wave treatment apparatus of water vapor in combustion air according to the present invention.

FIG. 2 is a perspective view showing an embodiment using an electromagnetic wave treatment apparatus of water vapor in combustion air according to the present invention.

FIG. 3 is a view showing an embodiment using an electromagnetic wave treatment apparatus of water vapor in combustion air according to the present invention, and showing the state that the apparatus is fitted on an engine which is an internal combustion engine of an automobile.

### BEST MODE FOR CARRYING OUT THE INVENTION

The present invention is described in detail below by reference to the embodiment in the case of applying the present invention to an internal combustion engine of an automobile.

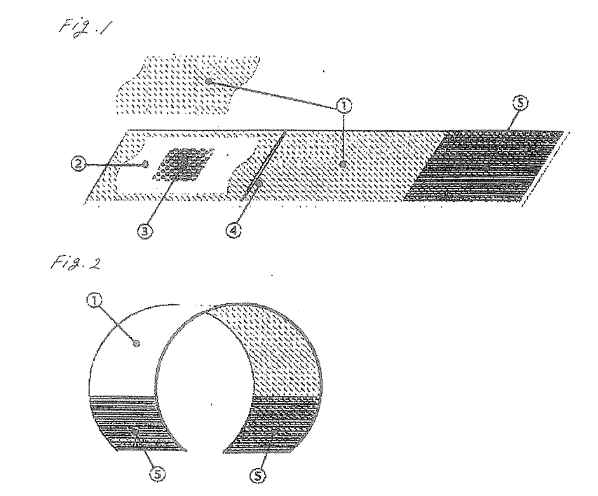

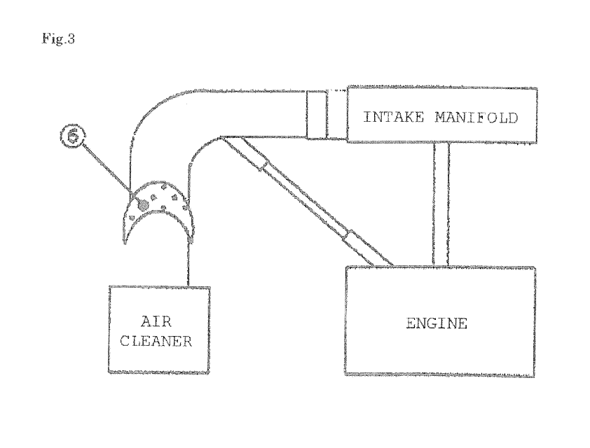

FIG. 1 is a perspective view showing the embodiment of the present invention, and a heat shield body 2 of an aluminum material is provided in a rectangular substrate 1 which prevents the outside air temperature.

A plurality of irradiators 3 made of ceramics are attached to the upper surface of the heat shield body 2, and a pocket 4 constituting a storage space placing the irradiator 3 therein is provided. A first planar fastener 5 is provided at one side of the substrate 1. The first planar fastener 5 can be detachable to a second planar fastener 5 on the back surface at the other side of the substrate 1, and the substrate is wound at a position of an air passage body 6 which easily absorbs heat, as shown in FIG. 3.

### EXAMPLES

In the electromagnetic wave treatment apparatus constituted as above, the combustion air from, for example, an air cleaner toward an internal combustion engine is irradiated with electromagnetic waves of 6 to 16 μm from the irradiators 3, whereby water molecules of water vapor in the combustion air are excited, and further molecular oscillation action occurs.

This action homogenizes temperature distribution of air (molecular level) when the combustion air has been compressed, and furthermore can suppress temperature unevenness of the combustion air. Ignition delay inevitably generated in the existing combustion is controlled to improve combustion efficiency, thereby the fuel consumption is reduced, and additionally, exhaust harmful substances such as carbon dioxide (CO₂), carbon monoxide (CO), hydrocarbon (HC), nitrogen oxide (NOₓ) and suspended particulate matter (PM), contained in an exhaust gas are reduced.

By mounting the electromagnetic wave treatment apparatus on the existing vehicles, the ignition delay of the predetermined combustion is improved, cleaning combustion in which combustion time has been prolonged is carried out, deposits in a combustion chamber are gradually cleaned by the cleaning combustion, and as a result, the combustion efficiency can gradually improved and increased. Furthermore, in the existing cars having mounted thereon a catalyst and DPF (NOₓ, PM reduction equipment) known as a post-treatment apparatus of exhaust gas, clogging of the catalyst and a DPF filter is prevented. This brings about a life-extending effect, and becomes a global warming countermeasure (improvement of fuel efficiency) that can inexpensively be carried out, and a method of preventing air pollution.

Table 2 shows comparative running test data in which the data in average of electrorrmagnetic wave treatment apparatus-mounted cars and electromagnetic wave treatment apparatus-unmounted cars in the past two years in the actual running distance per year by 106 diesel vehicles of a bus business office were used as databases, and reduction of fuel consumption of vehicles having the electromagnetic wave treatment apparatus amounted thereon was confirmed.

TABLE 2
Running test results by 106 diesel vehicles in bus business office

| Vehicle specification | Mitsubishi, Isuzu, Hino and Nissan diesels | | |
|---|---|---|---|
| Engine displacement | 4,850 to 20,080 cc | | |
| Apparatus specification | Unmounted | | Mounted |
| Test period | 2008 | 2009 | April 2010 to |
| | | | March 2011 |
| Running distance (km) | 3,999,995 | 3,979,532 | 3,950,683 |
| Fuel consumption (L) | 918,634 | 937,320 | 868,234 |
| Fuel cost (km/L) | 4.35 | 4.25 | 4.66 |

| | | |
|---|---|---|
| Average (km/L) | 4.30 | 4.55 |

| | |
|---|---|
| Fuel reduction (%) | 5.83 |

Table 3 is data in an exhaust smoke concentration test, in which the data of five electromagnetic wave treatment apparatus-mounted test vehicles were compared with the data of the same five electromagnetic wave treatment apparatus-unmounted test vehicles of the previous year and reduction of exhaust smoke concentration in the vehicles having mounted thereon the electromagnetic wave treatment apparatus was confirmed.

TABLE 3
Comparative test results in exhaust smoke concentration
by five diesel vehicles in bus business office

| Vehicle number | 0566 | 0303 | 0606 | 0702 | 0889 |
|---|---|---|---|---|---|
| Test period | May | May | May | June | June |
| | 2009 | 2009 | 2009 | 2009 | 2009 |
| Unmounted: Exhaust gas | 15 | 11 | 20 | 30 | 18 |
| smoke concentration (%) | | | | | |
| Test period | May | May | May | June | June |
| | 2010 | 2010 | 2010 | 2010 | 2010 |
| Mounted: Exhaust gas | 10 | 6 | 14 | 26 | 12 |
| smoke concentration (%) | | | | | |
| Improvement rate (%) | 33 | 45 | 30 | 13 | 33 |

Table 4 shows comparative running test data in which the data of electromagnetic wave treatment apparatus-mounted vehicles in the actual running per year by 23 gasoline fuel-efficient cars of a taxi business office were compared with the data of the electromagnetic wave treatment apparatus-unmounted cars in the previous year, and the fuel consumption of the vehicles having mounted thereon the electromagnetic wave treatment apparatus is reduced.

TABLE 4
Running test results by taxi business office (23 fuel-efficient cars)

| | |
|---|---|
| Vehicle specification | Toyota Prius (1NZ-1CM) |
| Engine displacement | 1.500 cc |

| | | |
|---|---|---|
| Apparatus specification | Unmounted | Mounted |
| Test period | Mar. 8, 2007 to | Mar. 8, 2008 to |
| | Apr. 7, 2007 | Apr. 7, 2008 |
| Running distance (km) | 140,058 | 152,654 |
| Fuel consumption (L) | 10,813 | 11,177 |
| Fuel cost (km/L) | 12.99 | 13.74 |

| | |
|---|---|
| Fuel reduction rate (%) | 5.8 |

Table 5 shows running test data regarding the fuel consumption between the electromagnetic wave treatment apparatus-mounted car and the electromagnetic wave treatment apparatus-unmounted car in the actual running per 2 months in one gasoline light vehicle in a postal business office, and it was confirmed that the fuel consumption of the electromagnetic wave treatment apparatus-mounted car was reduced remarkably. In addition it was also confirmed in a secondary test that when the electric wave treatment apparatus was removed, the fuel consumption was reduced to the original level.

TABLE 5
Running test results by gasoline light vehicle
(Adachi 41 Re 1919) in postal business office
Test: First time

| | Specification | | | |
|---|---|---|---|---|
| | Unmounted | | Mounted | |
| | Test Period | | | |
| | October | January | March | April |
| | 2000 | 2001 | 2001 | 2001 |
| Running distance (km) | 2,363 | 1,412 | 2,611 | 2,499 |
| Fuel consumption (L) | 282 | 166 | 286 | 251 |
| Fuel cost (km/L) | 8.38 | 851 | 9.13 | 9.96 |

| | | |
|---|---|---|
| Average (km/L) | 8.45 | 9.55 |

| | |
|---|---|
| Fuel reduction (%) | 13.0 |

Test: Second time

| | Specification | | | |
|---|---|---|---|---|
| | Unmounted | | Mounted | |
| | Test period | | | |
| | September 2001 | — | October 2001 | — |
| Running distance (km) | 1,916 | — | 2,407 | — |
| Fuel consumption (L) | 223 | — | 236 | — |
| Fuel cost (km/L) | 8.59 | — | 10.20 | — |

| | |
|---|---|
| Fuel reduction (%) | 18.7 |

Table 6 shows the measurement results of exhaust harmful substances at the time of idling by a simple exhaust gas analyzer in the gasoline light vehicle of Table 5, and it is seen from the measurement results that the effect of remarkably reducing exhaust harmful substances such as carbon dioxide (CO₂), carbon monoxide (CO), nitrogen oxide (NOₓ) and sulfur oxide (SOₓ), contained in an exhaust gas is observed, and the apparatus has excellent immediate effect.

TABLE 6
Idling measurement results by exhaust gas analyzer
of light vehicle (Adachi 41 Re 1919)

| | CO₂ | CO | NOₓ | SOₓ |
|---|---|---|---|---|
| Measurement gas item | (ppm) | (ppm) | (ppm) | (ppm) |
| Unmounted | 126,000 | 5,494 | 7 | 25 |
| Mounted | 99,000 | 2,551 | 0 | 2 |
| Improvement rate (%) | 21.4 | 53.5 | 100 | 92.0 |

| | |
|---|---|
| Simple measuring | GSV-350, manufactured by Testo K.K. |
| instrument | |
| Measurement date | Aug. 30, 2000 |

### INDUSTRIAL APPLICABILITY

The above Examples were described in the case that the electromagnetic wave treatment apparatus was mounted on an internal combustion engine of an automobile, but the electromagnetic wave treatment apparatus of the present invention can of course be mounted on an inhaled air part such as various burning appliances (a boiler, a stove and a drying oven), and various internal combustion engines (a gasoline engine, a diesel engine, a gas-fired engine, a turbine engine and the like).

### DESCRIPTION OF REFERENCE NUMERALS AND SIGNS

1 Substrate
2 Heat shield body
3 Irradiator
4 Storage space (pocket)
5 Planar fastener
6 Air passage body (duct hose)

1. An electromagnetic wave treatment method of combustion air, comprising irradiating combustion air fed to a combustion apparatus which extracts heat energy by burning materials to be burned, with electromagnetic waves, thereby exciting water molecules of water vapor in the combustion air.

2. The electromagnetic wave treatment method of combustion air according to claim 1, wherein the combustion apparatus is an internal combustion engine.

3. The electromagnetic wave treatment method of combustion air according to claim 1, wherein the combustion apparatus is a heat generation type combustion equipment.

4. An electromagnetic wave treatment apparatus of combustion air being mounted on a combustion apparatus which extracts heat energy by burning a material to be burned, comprising a substrate, a heat shield body attached to the substrate, an irradiator provided on the heat shield body and irradiating electromagnetic waves toward ccmbustion air, and a storage space storing the irradiator.

5. The electromagnetic wave treatment apparatus according to claim 4, wherein the irradiator is formed by applying pasty ceramics to the surface of a base material comprising a paper.

6. The electromagnetic wave treatment apparatus of combustion air according to claim 4, wherein the irradiator is made of aluminum.

7. The electromagnetic wave treatment apparatus of combustion air according to claim 4, wherein the substrate is formed in a band form, and has a joint part at the end thereof.

8. The electromagnetic wave treatment apparatus of combustion air according to claim 6, wherein the joint part is a planar fastener.

9. The electromagnetic wave treatment apparatus of combustion air according to claim 4, wherein the combustion apparatus is an internal combustion engine.

10. The electromagnetic wave treatment apparatus of combustion air according to claim 4, wherein the combustion apparatus is a heat generation type combustion equipment.
